(19) United States
(12) Patent Application Publication
(10) Pub. No.: US 2008/0082665 A1
(43) Pub. Date: Apr. 3, 2008

(54) METHOD AND APPARATUS FOR DEPLOYING SERVERS

(76) Inventors: Sean L. Dague, Poughkeepsie, NY (US); Daniel McCune Smith, Hillsboro, OR (US)

Correspondence Address: IBM CORP (YA);C/O YEE & ASSOCIATES PC, P.O. BOX 802333, DALLAS, TX, 75380, US

(21) Appl. No.: 11/537,799

(22) Filed: Oct. 2, 2006

(51) Int. Cl. G06F 15/173

(52) U.S. Cl. 709/226

(57) ABSTRACT

A computer implemented method, apparatus, and computer usable program code for managing servers. Images are sent to a set of logical partitioned computers during a first period of time in which less use of network resources by the set of logical partitioned computers is present compared to a second period of time, subsequent to the first period of time to form a set of pre-loaded base images. The new server process is started in a logical partition on a computer in the set of logical partitioned computers utilizing a pre-loaded base image from the set of pre-loaded base images for the new server process, wherein use of network resources are reduced during the second period of time because transferring the pre-loaded base image to the computer is avoided during the second period of time in response to a condition requiring a new server process that occurs during the second period of time.

### BACKGROUND OF THE INVENTION

1. Field of the Invention

The present invention relates generally to an improved data processing system and in particular to a method and apparatus for managing servers. Still more particularly, the present invention relates to a computer implemented method, apparatus, and computer usable program code for managing the initialization of servers.

2. Description of the Related Art

A data center contains a number of fixed physical pieces of hardware to accomplish a set of tasks. This hardware typically includes data processing systems that are configured with a specific role, such as a domain name system server, a mail server, a web server, a file server, or an application server. A data center may use multiple data processing systems that have logical partitions. These data processing systems are also referred to as logical partitioned (LPAR) data processing systems. Logical partitioned functionality within a data processing system allows multiple copies of a single operating system or multiple heterogeneous operating systems to be simultaneously run on a single data processing system platform. A logical partition, within which an operating system image runs, is assigned a subset of the platform's resources. A logical partition is also referred to as a virtual machine. These platform allocable resources include one or more architecturally distinct processors with their interrupt management area, regions of system memory, and input/output (I/O) adapter bus slots. The partition's resources are represented by the platform's firmware to the operating system image.

Each distinct operating system or image of an operating system running within a platform is protected from each other such that software errors on one logical partition do affect the correct operations of any of the other partitions. Each partition within a logical partitioned data processing system may be booted and shut down over and over without having to power-cycle the entire data processing system.

These different partitions are used to provide the different functions or roles for a data center. For example, a single computer may have multiple partitions in which each partition provides a different role. For example, one partition may provide mail server functionality while two other partitions provide web server functionalities.

In managing a data center with multiple computers of this type, it is desirable to provide an on the fly response to demands and changes in traffic. For example, if a new product is put on a website and demand increases beyond what current web servers for the website can handle, it is desirable to bring up additional web servers to handle the increased amount of traffic. Re-provisioning a computer to take on a new role is a time consuming process and may be error prone. Changing the role in a computer is performed infrequently even if a specific service is running beyond the capacity, such as when web traffic spikes or increases beyond what current web servers can handle.

Currently, one or more new web servers may be brought online to handle increased traffic. These web servers are brought online by transferring an image to each machine on which a web server is to be installed. This image contains the operating system and programs for the web server. Depending on the size of the image, transferring an image to several computers may take thirty minutes. The amount of time needed to re-provision or bring online new web servers in a logical partitioned data processing system often takes a large enough amount of time that users of a particular service will notice a slow down or an inability to process transactions for some period of time until the new web servers can be brought online.

With current systems, the downloading of images during peak traffic or heavy traffic loads only makes the situation worse and decreases the ability of web servers to respond. Although this type of system provides for increased flexibility in responding to different amounts of traffic, it would be desirable to reduce the amount of time needed to bring up new servers to respond to changes in demand.

### SUMMARY OF THE INVENTION

The present invention provides a computer implemented method, apparatus, and computer usable program code for managing servers. Images are sent to a set of logical partitioned computers during a first period of time in which less use of network resources by the set of logical partitioned computers is present compared to a second period of time, subsequent to the first period of time to form a set of pre-loaded base images. The new server process is started in a logical partition on a computer in the set of logical partitioned computers utilizing a pre-loaded base image from the set of pre-loaded base images for the new server process, wherein use of network resources are reduced during the second period of time because transferring the pre-loaded base image to the computer is avoided during the second period of time in response to a condition requiring a new server process that occurs during the second period of time.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of an exemplary logical partitioned platform in which illustrative embodiments may be implemented;

FIG. 4 is a diagram illustrating component use to manage servers in a data center in accordance with an illustrative embodiment;

FIG. 5 is a flowchart of a process for starting a server in accordance with an illustrative embodiment;

FIG. 6 is a flowchart of a process for starting a server in accordance with an illustrative embodiment;

FIG. 7 is a flowchart of a process for updating images in accordance with an illustrative embodiment;

FIG. 8 is a flowchart of a process for creating a primed base image in accordance with an illustrative embodiment; and

FIG. 9 is a flowchart of a process for initializing an image on a computer in accordance with an illustrative embodiment.

### DETAILED DESCRIPTION OF THE PREFERRED EMBODIMENT

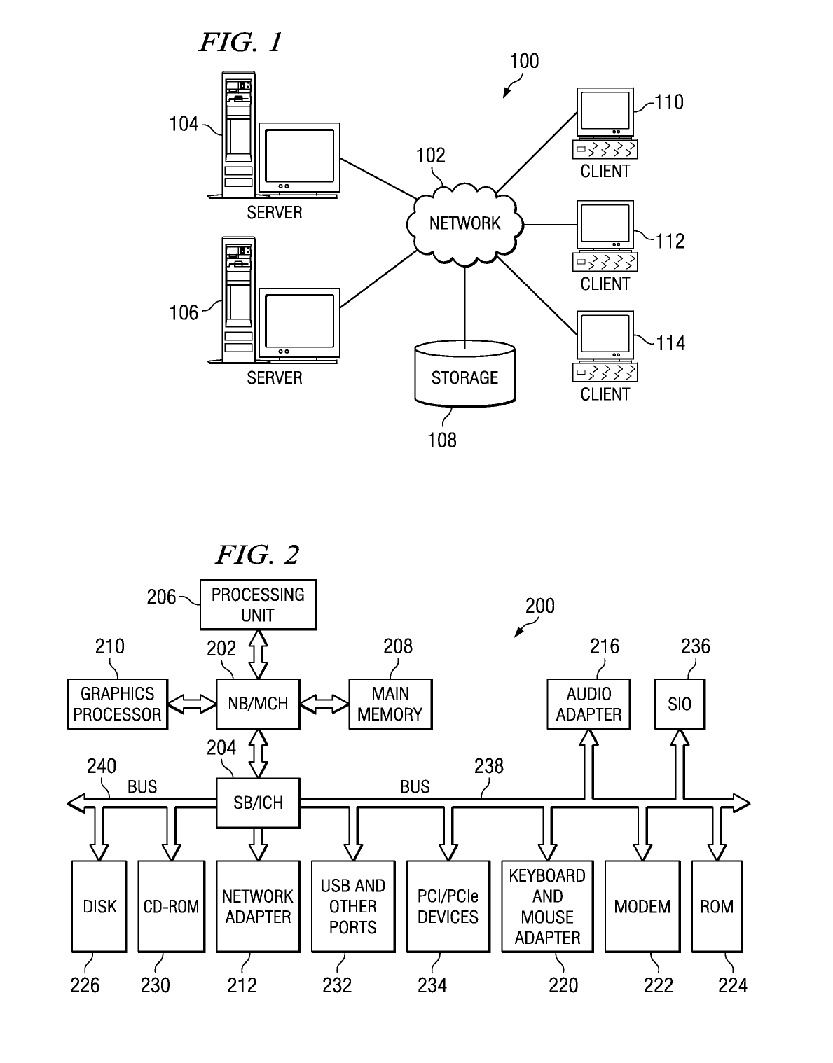

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, clients 110, 112, and 114 connect to network 102. These clients 110, 112, and 114 may be, for example, personal computers or network computers. In the depicted example, server computer 104 and server computer 106 may be part of a data center and may provide server functions such as, for example, a domain name system (DNS) server, e-mail server, Web server, file server, and/or application server to clients, such as, clients 110, 112, and 114. Network data processing system 100 may include additional servers, clients, and other devices not shown. These server computers also may be configured as part of a cluster for the data center, depending on the implementation and may be logically partitioned.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server computer 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be implemented using a large symmetric multi-processor data processing system, such as IBM eServer P690, available from International Business Machines Corporation, DHP9000 Superdome Enterprise Server, available from Hewlett-Packard Company, and the Sunfire 15K server, available from Sun Microsystems, Inc. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, as a client, data processing system 200 also may be a tablet computer, laptop computer, a personal digital assistant, or telephone device.

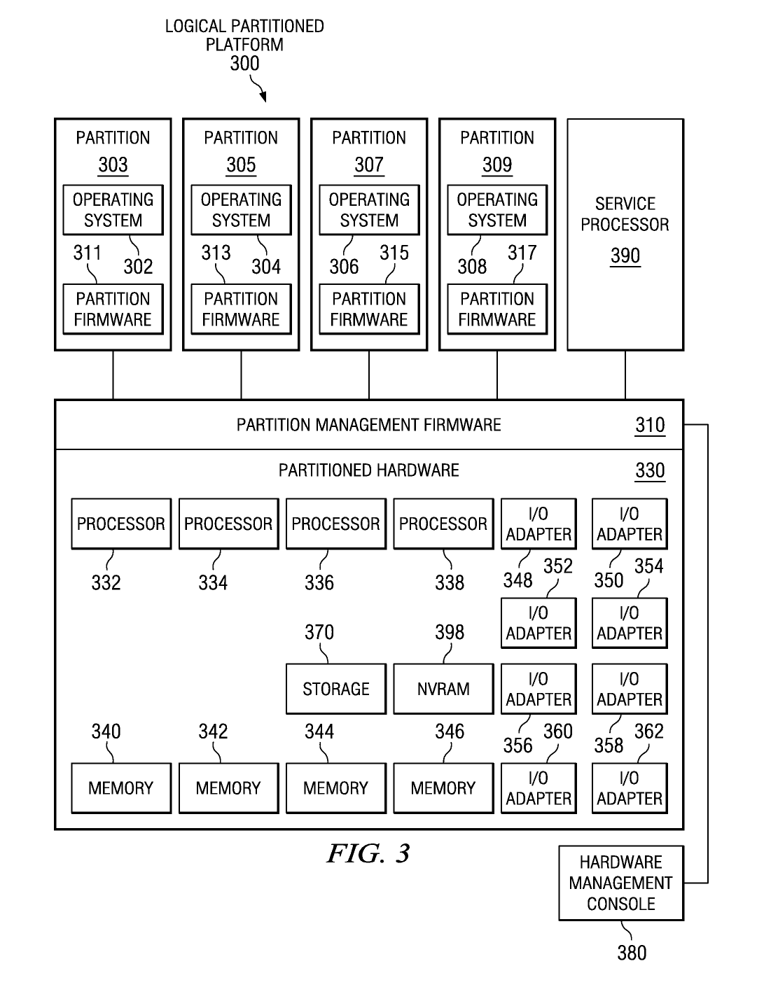

With reference now to FIG. 3, a block diagram of an exemplary logical partitioned platform is depicted in which illustrative embodiments may be implemented. The hardware in logical partitioned platform 300 may be implemented using, for example, data processing system 200 in FIG. 2. Logical partitioned platform 300 includes partitioned hardware 330, operating systems 302, 304, 306, 308, and partition management firmware 310. Operating systems 302, 304, 306, and 308 may be multiple copies of a single operating system or multiple heterogeneous operating systems simultaneously run on logical partitioned platform 300. These operating systems may be implemented using OS/400, which are designed to interface with a partition management firmware, such as Hypervisor, which is available from International Business Machines Corporation. OS/400 is used only as an example in these illustrative embodiments. Of course, other types of operating systems, such as AIX and Linux, may be used depending on the particular implementation. Operating systems 302, 304, 306, and 308 are located in partitions 303, 305, 307, and 309. Hypervisor software is an example of software that may be used to implement partition management firmware 310 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 311, 313, 315, and 317. Partition firmware 311, 313, 315, and 317 may be implemented using initial boot strap code, IEEE-1275 Standard Open Firmware, and runtime abstraction software (RTAS), which is available from International Business Machines Corporation. When partitions 303, 305, 307, and 309 are instantiated, a copy of boot strap code is loaded onto partitions 303, 305, 307, and 309 by platform firmware 310. Thereafter, control is transferred to the boot strap code with the boot strap code then loading the open firmware and RTAS. The processors associated or assigned to the partitions are then dispatched to the partition's memory to execute the partition firmware.

Partitioned hardware 330 includes a plurality of processors 332-338, a plurality of system memory units 340-346, a plurality of input/output (I/O) adapters 348-362, and a storage unit 370. Each of the processors 332-338, memory units 340-346, NVRAM storage 398, and I/O adapters 348-362 may be assigned to one of multiple partitions within logical partitioned platform 300, each of which corresponds to one of operating systems 302, 304, 306, and 308.

Partition management firmware 310 performs a number of functions and services for partitions 303, 305, 307, and 309 to create and enforce the partitioning of logical partitioned platform 300. Partition management firmware 310 is a firmware implemented virtual machine identical to the underlying hardware. Thus, partition management firmware 310 allows the simultaneous execution of independent OS images 302, 304, 306, and 308 by virtualizing all the hardware resources of logical partitioned platform 300.

Service processor 390 may be used to provide various services, such as processing of platform errors in the partitions. These services also may act as a service agent to report errors back to a vendor, such as International Business Machines Corporation. Operations of the different partitions may be controlled through a hardware management console, such as hardware management console 380. Hardware management console 380 is a separate data processing system from which a system administrator may perform various functions including reallocation of resources to different partitions.

The illustrative embodiments provide a computer implemented method, apparatus, and computer usable program code for managing servers. Images are sent to a set of logical partitioned computers during a first period of time in which less usage of network resources is present as compared to a second subsequent period of time. These images on the set of logical partitioned computers form a set of pre-loaded base images. When a condition requiring a new server process occurs during the second period of time, a new server process is started in a logical partition on a computer within the set of logical partitioned computers. This new server process is started using a pre-loaded base image from the set of pre-loaded base images. By using the pre-loaded base image, use network resources are reduced during the second period of time because transferring of an image to the computer is avoided in bringing online a new server process.

An example of a condition requiring a new server process is when a new item or a sale offered on a website results in large amounts of users visiting the website and initiating transactions. This increased traffic to the website may be such that current web servers are unable to handle the traffic without delays that are considered unacceptable for a particular service level agreement. With this condition, one or more new web servers are initiated as the new server processes within different logical partitions in a set of logical partitioned computers. The new process may be brought online on an unused partition. Alternatively, a currently used partition may be altered from the current service to the new service.

In each instance, additional traffic on the network is avoided because images are not downloaded to start these new services. These images were previously loaded during another period of time when traffic was lower than the current period of time. In this manner, rapid provisioning and re-provisioning of partitions without moving large amounts of operating system image data during times of heavy traffic is provided.

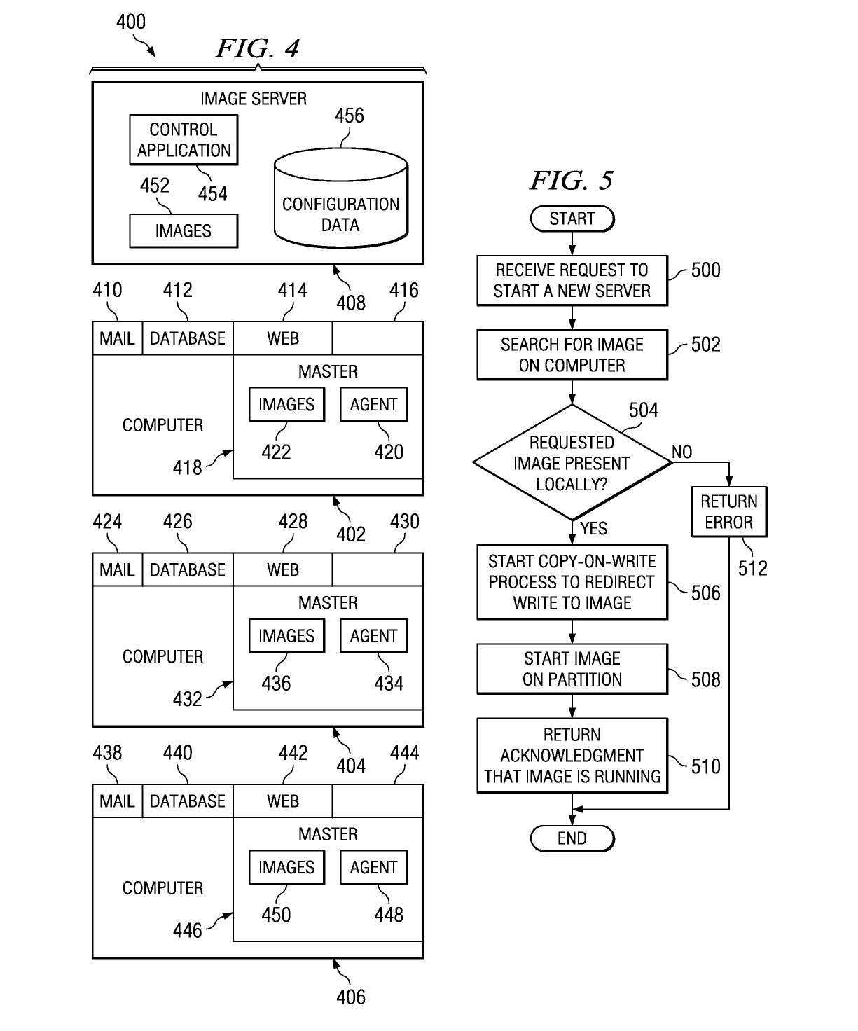

Turning now to FIG. 4, a diagram illustrating component use to manage servers in a data center is depicted in accordance with an illustrative embodiment. In this example, data center 400 includes computer 402, computer 404, computer 406, and image server 408. These components may be implemented using data processing system 200 in FIG. 2. In this example, computer 402 contains partitions 410, 412, 414, 416, and 418. Master partition 418 is typically the initial logical partition and is used to set up and control partitions within the computer. In these illustrative embodiments, the master partition is not shut down during the operation of a data processing system. The master partition is a partition in which processes and information for managing the other partitions may be located. Partitions 410, 412, 414, and 416 are referred to as client partitions.

Master partition 418 contains agent 420, which is used to receive and store images 422 within computer 402. Additionally, agent 420 also handles requests to start and stop servers within computer 402. Images 422 are also located in master partition 418 and are used to configure servers in partitions 410, 412, 414, and 416. These servers may provide different roles or functions such as, for example, a domain name system server, a web server, a mail server, a database server, and an application server. Of course, other roles other than these may be provided depending on the particular implementation.

Each image in images 422 contains an operating system, applications, configuration information, and other information needed for a particular role or server function. A first boot of the image automatically configures system services using dynamic host configuration protocol (DHC), which is a protocol used by a device to request and obtain an internet address. Alternatively, another configuration storage method, such as a directory based service may be used. An example of a director based service is a lightweight directory access protocol (LDAP) service. This protocol is used to query and modify directory services.

In this example, partition 410 is configured to function as a mail server, partition 412 is configured to function as a database server, and partition 414 is configured to function as a web server. As depicted, partition 416 currently does not have an assigned function. Of course the roles illustrated may differ depending on the particular purpose of a computer, such as computer 402. For example, computer 402 may be designated as an e-mail computer in which all of the partitions run e-mail server processes.

In the illustrative embodiments, agent 420 may configure partition 416 to provide a function, such as a web server, using images 422. Each of these images, in these examples, contains the applications and information needed to start a particular function. Images 422 contains an image for each function that computer 402 may perform. In these examples, an image contains all of the information needed to set up and run an operating system in a partition.

As illustrated, computer 404 contains partitions 424, 426, 428, and 430, and master partition 432. Master partition 432 also includes agent 434 and images 436. Agent 434 manages images 436 and the starting and stopping of servers.

In this example, partition 424 is configured to function as a mail server, partition 426 is configured to function as a database server, and partition 428 is configured to function as a web server. Partition 430 is unused for any function in this example.

Computer 406 contains partitions 438, 440, 442, and 444. Computer 406 also contains master partition 446. This partition also includes agent 448 and images 450. As with the other computers, agent 448 manages images 450 and the starting and stopping of server functions within the partitions.

Images 422, 436, and 450 are copies of images 452 located on image server 408. The sending of images to computers 402, 404, and 406 are controlled through control application 454. Control application 454 ensures that images 422, 436, and 450, are up-to-date with the most current images for data center 400. In these illustrative examples, the identification of the version of images located on computers 402, 404, and 406 are stored in configuration data 456. Additionally, control application 454 also stores information as to the server functions currently running on computers 402, 404, and 406 within configuration data 456.

In the illustrative examples, images 452 are sent and used to update images 422, 436, and 450 during non-peak times using mechanisms currently used to update images on computers. Thus, if a new web server image is included or updated in images 452, that web server image may be sent to computers 402, 404, and 406 through agents 420, 434, and 448 respectively. Control application 454 determines whether the images on computers 402, 404, and 406 are the most up-to-date images. If the most up-to-date or current images are not present, control application 454 updates the images through agents 420, 434, and 448 on the master partitions 418, 432, and 446, respectively.

In these examples, only a single image for a particular function or role needs to be maintained within a set of images stored on a computer even though that image may be reused a number of different times. For example, a single web server image in images 422 may be used to initiate multiple web servers in the partitions in computer 402. This feature is implemented in these examples using a copy-on-write technique. This technique provides each partition the same pointer to the image. Whenever one of the partitions in computer 402 attempts to write or modify the copy of the image for the web server, the writes or changes are stored in another location, leaving the original image unchanged.

Thus, with the copy-on-write process, the base primed image is not modified and may be used to bring online multiple application instances on the same computer without inconsistencies. This feature also reduces the amount of space needed to store images because duplicate images are unneeded.

The different embodiments provide for a faster initiation or instantiation of server functions on computers 402, 404, and 406 through pre-populating or pre-loading images 422, 436, and 450 prior to those images being needed for different server functions within data center 400. Thus, with distributing base images to all of the different computers within data center 400 times when network usage is lower, no significant network overhead is needed to bring new instances of different server roles online. This technique in the illustrative embodiments avoids using existing network resources to copy an image from image server 408 to a given physical host machine during a time when higher or larger amounts of traffic may be experienced at data center 400.

Control application 454 also may monitor the load for the different partitions in computers 402, 404, and 406. In these examples, the load is the amount of requests or work being performed by each partition. This monitoring may be performed through agents 420, 434, and 448 using known monitoring systems to monitor the amount of traffic or request being handled by the different partitions. Control application 454 may initiate or start new servers using different load balancing strategies that are currently used.

The different illustrative embodiments provide an added benefit by an ability to upgrade a server that is currently functioning without incurring downtime. Even if only a single virtual instance of a given partition is running, a new partition may be started with an updated image, rolled into the load balancing scheme, and handling requests before the existing partition is taken offline.

In these examples, images 452 are implemented using an operating system image with the appropriate applications for a particular role or function. This image is turned into a “primed” base image for distribution to logical partitioned computers in data center 400. This process includes scanning and tagging all data in the operating system image that may change when the operating system is booted for the first time. The information that may change includes network storage and device attributes at both the operating system and application level. This information is tagged and may be modified when the image is booted. Alternatively, the information may be removed or altered in a manner that causes the information to be initialized upon the first boot of the operating system image on a computer.

When the image is run for the first time, agents 420, 434, and 448 may configure the tagged information gathered from configuration database 456. Alternatively, this modification of the tagged data may be performed through a process located in the image itself.

The description of data center 400 is presented for purposes of describing the different features of the illustrative embodiments and is not meant to imply any architectural limitations on the manner in which these features may be implemented. For example, although four computers are show as providing server functions in data center 400, other numbers of computers may be used.

Turning now to FIG. 5, a flowchart of a process for starting a server is depicted in accordance with an illustrative embodiment. The process illustrated in FIG. 5 may be implemented in an agent, such as agent 420 in FIG. 4.

The process begins by receiving a request to start a new server (step 500). The process searches for an image on a computer (step 502). This image is one that contains the appropriate applications for the role or function of the new server. For example, one image may be for the web server function while another image may be for an e-mail server function. Next, the process determines if the requested image is present locally on the computer (step 504). If the image is present locally, the process starts a copy-on-write process to redirect a write to an image (step 506). Although these illustrative embodiments use a copy-on-write process, other mechanisms may be implemented to preserve the original image from which the server process is started.

The image is then started on the partition (step 508). Finally, the process returns an acknowledgement that the image is running (step 510) with the process terminating thereafter. In these examples, the acknowledgment is used by the requestor, a control application, to track servers that are currently running in a data center.

Turning back to the determination made in step 504, if the requested image is not present locally, the process returns an error (step 512). The process then terminates.

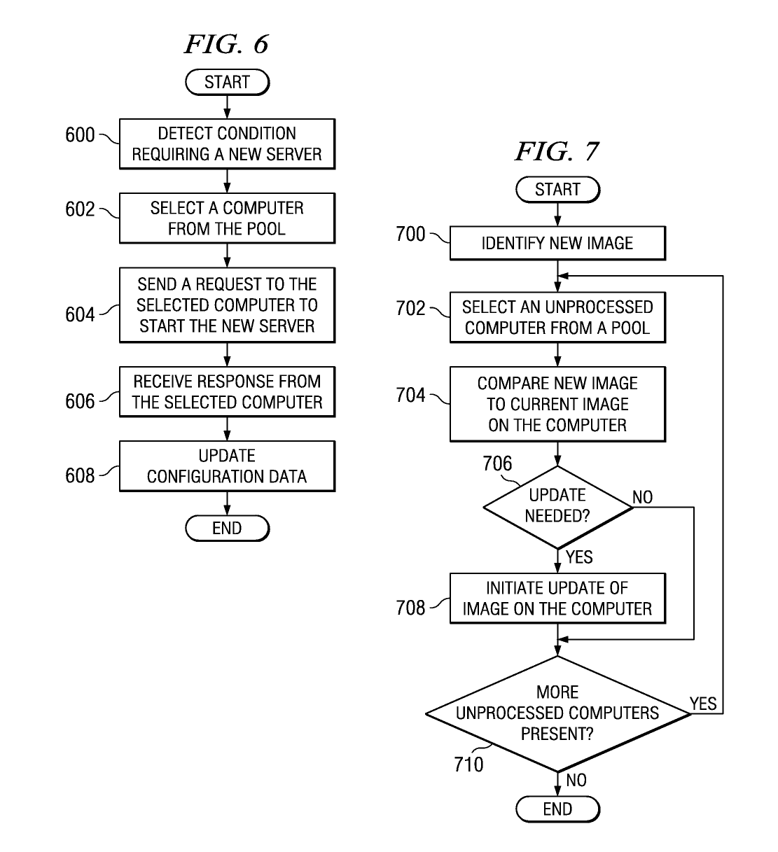

Turning now to FIG. 6, a flowchart of a process for starting a server is depicted in accordance with an illustrative embodiment. The process illustrated in FIG. 6 may be implemented in an application, such as control application 454 in FIG. 4.

The process begins by detecting a condition requiring a new server (step 600). In these examples, the condition in step 600 may be, for example, the control application detecting that the processing of requests takes more than some threshold amount of time or that the traffic has risen above a threshold value. This condition also may be initiated by user input requesting the starting of a new server.

Next, a computer is selected from the pool (step 602). The selection of a server in step 602 may be made using different mechanisms. For example, a round robin mechanism may be used. Alternatively, the process may select a server having the least amount of traffic or requests being processed. Additionally, the step may include looking for computers in which partitions are empty or partitions containing servers that may be reallocated for a new server. For example, a computer in which all partitions are being used may be selected over a computer in which a partition is free. This situation may arise when the computers with all partitions being used are ones that are for functions having little or no traffic, while the computer with a free partition is handling a large number of requests.

A request is sent to the selected computer to start the new server (step 604). A response is received from the selected computer (step 606). Finally, the configuration data is updated (step 608) with the process terminating thereafter.

Turning now to FIG. 7, a flowchart of a process for updating images is depicted in accordance with an illustrative embodiment. The process illustrated in FIG. 7 may be implemented in an application, such as control application 454 in FIG. 4. The process in this figure is used to ensure that images at the different computers in a data center remain up-to-date and consistent.

The process begins by identifying a new image (step 700). An unprocessed computer is selected from a pool (step 702). The new image is compared to the current image on the computer (step 704). Next, the process determines if an update to the image is needed (step 706). If an update is needed in step 706, the process initiates an update of the image on the computer (step 708).

A further determination is made as to whether more unprocessed computers are present (step 710). If more unprocessed computers are not present, the process terminates. However, if more unprocessed computers are present, the process returns to step 702 to select an unprocessed computer from the pool. Additionally, turning back to the determination made in step 706, if the process determines an update is not needed, the process proceeds to step 710 as described above.

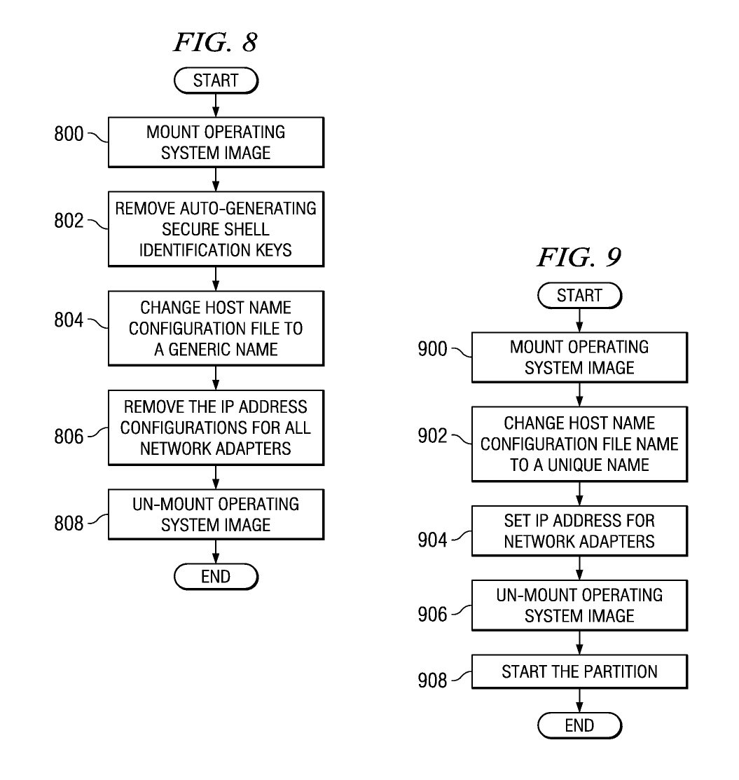

Turning now to FIG. 8, a flowchart of a process for creating a primed base image is depicted in accordance with an illustrative embodiment. The process illustrated in FIG. 8 may be implemented in an application, such as control application 454 in FIG. 4.

The process begins by mounting the operating system image (step 800). Next, auto-generating secure shell identification keys are removed (step 802). The host name of the configuration file is changed to a generic name (step 804). The Internet Protocol (IP) address configurations are then removed for all of the network adapters (step 806). Finally, the operating system image is un-mounted (step 808) with the process terminating thereafter.

Turning now to FIG. 9, a flowchart of a process for initializing an image on a computer is depicted in accordance with an illustrative embodiment. The process illustrated in FIG. 9 may be implemented in a process, such as agent 420 in FIG. 4.

The process begins by mounting the operating system image (step 900). The host name of the configuration file is changed to a unique name (step 902). IP addresses for the network adapters are set (step 904). The operating system image is un-mounted (step 906). Finally, the partition is started (step 908) with the process terminating thereafter.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Thus, the illustrative embodiments provide a computer implemented method, apparatus, and computer usable program code for managing servers. Images are sent to a set of logical partitioned computers during a first period of time in which less use of network resources are present as compared to a second subsequent period of time to form a set of pre-loaded base images. When a condition requiring a new server or server process is present during the second period of time, the new server process is started in a logical partition on a computer in the set of logical partition computers. This new server process is started using one of the pre-loaded base images from the set of pre-loaded base images. In this manner, the use of resources is reduced during the second period of time because transferring a pre-loaded base image to the computer is avoided.

The different illustrative embodiments may be implemented for use in a system, such as a data center. The different features found in the different embodiments may be implemented in any collection of logically partitioned data processing systems that provide server functions to clients.

In these examples, the different embodiments may be implemented using agents on the logical partitioned computers and a control application on a server computer. The agents execute on a master partition and are used to control the receipt of images and the starting and stopping of servers on the logical partitioned systems. In these examples, the control application distributes images to the agents and also monitors traffic to determine when new servers are needed and when servers may be removed. Further, the control application also is used to maintain updated or current images on the different logical partitioned computers.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing servers, the computer implemented method comprising:
sending images to a set of logical partitioned computers during a first period of time in which less use of network resources by the set of logical partitioned computers is present compared to a second period of time subsequent to the first period of time to form a set of pre-loaded base images; and
responsive to a condition requiring a new server process that occurs during the second period of time, starting the new server process in a logical partition on a computer in the set of logical partitioned computers utilizing a pre-loaded base image from the set of pre-loaded base images for the new server process, wherein use of network resources are reduced during the second period of time because transferring the pre-loaded base image to the computer is avoided during the second period of time.

2. The computer implemented method of claim 1 further comprising:
mounting an image;
identifying information that changes when first booting the image to form identified information; and
modifying the identified information to form modified information, wherein the modified information is changed for use by a particular logical partition when the image is used in the particular partition.

3. The computer implemented method of claim 1, wherein the modifying step comprises:
tagging the identified information.

4. The computer implemented method of claim 1, wherein the modifying step comprises:
changing the identified information such that the identified information is changed for use by the particular logical partition when the image is first booted by the logical partition.

5. The computer implemented method of claim 1, wherein the starting step comprises:
sending a request to start the new process to an agent executing in a base partitioned in the computer in the set of logical partitioned computers.

6. The computer implemented method of claim 1, wherein the starting step comprises:
receiving a request to start the new server process;
locating the image on the computer in response to receiving the request; and
starting the computer in which modifications to the image are stored in another location rather than in the image, wherein the image remains unchanged and may be reused for other instances of the new server process on the computer.

7. The computer implemented method of claim 6, wherein the process is a copy-on-write process.

8. The computer implemented method of claim 1, wherein the sending step comprises:
determining whether a selected image designated for a selected computer in the set of logical partitioned computers is present on the selected computer; and
responsive to a determination that the selected image is absent on the selected computer, sending the selected image to each computer.

9. The computer implemented method of claim 8, wherein the selected image is absent on the selected computer if a different version of the selected image is present on the selected computer.

10. A data center comprising:
a network;
a set of server computers connected to the network; and
an image server connected to the network, wherein the image server sends images to the set of server computers during a first period of time in which use of network resources is lower than during a second period of time subsequent to the first period of time; detects a need for a new server process during the second period of time after the images have been sent to the set of server computers; and starts the new server process on a selected computer in the set of server computers with a selected image for the server process in response to detecting the need, wherein the new server process on the selected computer is started without using network resources in the network to send the selected image to the selected computer.

11. The data center of claim 10, wherein agents on the set of server computers receive the images and start server processes.

12. The data center of claim 10, wherein a control application on the image server sends the images to the set of server computers and detects the need for the new server process.

13. A computer program product comprising:
a computer usable medium having computer usable program code for managing servers, the computer program medium comprising:
computer usable program code for sending images to a set of logical partitioned computers during a first period of time in which less use of network resources by the set of logical partitioned computers is present compared to a second period of time subsequent to the first period of time to form a set of pre-loaded base images; and
computer usable program code, responsive to a condition requiring a new server process that occurs during the second period of time, for starting a new server process in a logical partition on a computer in the set of logical partitioned computers utilizing a pre-loaded base image from the set of pre-loaded base images for the new server process, wherein use of network resources are reduced during the second period of time because transferring the pre-loaded base image to the computer is avoided during the second period of time.

14. The computer program product of claim 13 further comprising:
computer usable program code for mounting an image;
computer usable program code for identifying information that changes when first booting the image to form identified information; and
computer usable program code for modifying the identified information to form modified information, wherein the modified information is changed for use by a particular logical partition when the image is used in the particular partition.

15. The computer program product of claim 13, wherein the computer usable program code for modifying the identified information to form modified information, wherein the modified information is changed for use by a particular logical partition when the image is used in the particular partition, comprises:
computer usable program code for changing the identified information such that the identified information is changed for use by the particular logical partition when the image is first booted by the logical partition.

16. The computer program product of claim 13, wherein the computer usable program code, responsive to a condition requiring a new server process that occurs during the second period of time, starting the new server process in a logical partition on a computer in the set of logical partitioned computers utilizing a pre-loaded base image from the set of pre-loaded base images for the new server process, wherein use of network resources are reduced during the second period of time because transferring the pre-loaded base image to the computer is avoided during the second period of time, comprises:
computer usable program code for sending a request to start the new process to an agent executing in a base partitioned in the computer in the set of logical partitioned computers.

17. The computer program product of claim 13, wherein the computer usable program code, responsive to a condition requiring a new server process that occurs during the second period of time, starting the new server process in a logical partition on a computer in the set of logical partitioned computers utilizing a pre-loaded base image from the set of pre-loaded base images for the new server process, wherein use of network resources are reduced during the second period of time because transferring the pre-loaded base image to the computer is avoided during the second period of time, comprises:
computer usable program code for receiving a request to start the new server process;
computer usable program code for locating the image on the computer in response to receiving the request; and
computer usable program code for starting the computer in which modifications to the image are stored in another location rather than in the image, wherein the image remains unchanged and may be reused for other instances of the new server process on the computer.

18. The computer program product of claim 13, wherein the computer usable program code for sending a request to start the new process to an agent executing in a base partitioned in the computer in the set of logical partitioned computers comprises:
computer usable program code for determining whether a selected image designated for a selected computer in the set of logical partitioned computers is present on the selected computer; and
computer usable program code, responsive to a determination that the selected image is absent on the selected computer, for sending the selected image to each computer.

19. The computer program product of claim 18, wherein the selected image is absent on the selected computer if a different version of the selected image is present on the selected computer.

20. A data processing system comprising:
a bus;
a communications unit connected to the bus;
a storage device connected to the bus, wherein the storage device includes computer usable program code; and
a processor unit connected to the bus, wherein the processor unit executes the computer usable program code to send images to a set of logical partitioned computers during a first period of time in which less use of network resources by the set of logical partitioned computers is present compared to a second period of time subsequent to the first period of time to form a set of pre-loaded base images; and start a new server process in a logical partition on a computer in the set of logical partitioned computers utilizing a pre-loaded base image from the set of pre-loaded base images for the new server process, wherein use of network resources are reduced during the second period of time because transferring the pre-loaded base image to the computer is avoided during the second period of time in response to a condition requiring a new server process that occurs during the second period of time.
